(19) United States
(12) Patent Application Publication
(10) Pub. No.: US 2016/0267402 A1
(43) Pub. Date: Sep. 15, 2016

(54) System and Method for Maximizing Hotel Room Occupancy

(71) Applicant: James Szabo, Windermere, FL (US)

(72) Inventor: James Szabo, Windermere, FL (US)

(21) Appl. No.: 15/068,612

(22) Filed: Mar. 13, 2016

Related U.S. Application Data
(60) Provisional application No. 62/131,869, filed on Mar. 12, 2015.

(51) Int. Cl. G06Q 10/02; G06Q 30/02

(52) U.S. Cl. CPC G06Q 10/02; G06Q 30/0241

(57) ABSTRACT

A system and method are disclosed to increase the occupancy at a hotel, along with allowing for variable check-in/check-out times. The system allows for the scheduling of the personnel at the hotel based on the variable check-in/check-out times.

### REFERENCE TO RELATED CASE

This application claims priority under 35 U.S.C. §119 (e) to provisional application no. 62/131,869 filed on Mar. 12, 2015, the contents of which are hereby incorporated by reference in their entirety.

### BACKGROUND OF THE INVENTION

### Field of the Invention

While making hotel reservations, guests have ability to choose their month and day of arrival. The hotel's reservation system will then inform the guests about early check-in/late check-out policies and fees. This typical model does not accommodate guests who prefer or need an earlier check-in and/or late check-out, this inflexibility leads to low guest satisfaction scores, a decrease in occupancy potential, and increase in labor costs.

There is a direct link between the ability of a hotel to accommodate check-in and/or late check-out requests of their customers and guest satisfaction scores. When a guest arrives to the property prior to set check in time, this guest may have to wait several hours before being able to occupy a room. However, if the hotel's personnel would have known ahead of time, they could place this room at the top of the cleaning list or move this reservation to a room that is currently ready in order to accommodate the guest immediately, thereby avoiding the wait. This thinking also pertains to late departures. If the property management knew in advance the exact number of available late departures, they would be better able to staff the cleaning crew and accommodate the guests with the later check-out.

The hotels would not only be able to better accommodate guests, but also they could increase occupancy potential of the hotel. An efficient forecasting of times when guests arrive and depart results in the increased occupancy. This forecast should include the exact time of check-ins and check-outs, which is currently not available. The main profit center of any hotel is room revenue. Thus, the goal of any hotel is to maximize occupancy at the highest possible rate to ensure maximum profit. If the hotel can accommodate guests during the non-standard times, then the hotel can optimize the value of the room from a per-hour perspective. Moreover, when check-ins and check-outs are spaced throughout the day, there will be fewer rooms that sit empty and the continuous flow in the room occupancy will increase the value of each room.

Additionally, the ability to have check-ins and check-outs staged throughout the day will alleviate stress of having everyone trying to check-in/check-out at the same time, or have the rooms cleaned by a certain time will increase the labor efficiency of staff. This method will reduced the number of unturned rooms. An unturned room occurs when a guest stays later than projected (allowed) and the housekeeping services have to bypass that room while performing their cleaning duties. This room is likely to remain un-serviced until the following day due to the specifics of scheduling of housekeeping services both external and internal. Otherwise, when a guest departs late, the housekeeping service has to stay past their scheduled hours. Because it is currently not possible to predict the daily number of late checkouts and the needed number of housekeeping team members to accommodate these late departures, there is an associated increased labor cost and time loss that is the direct result of this flaw in the current system. It is important to find a way that would allow the hotel to update the number of late departures monthly, weekly, and daily and to schedule the work hours of housekeeping team accordingly. In turn, this will considerably reduce labor over time and additional labor costs while adding a significant amount of room revenue to the bottom line.

### SUMMARY OF THE INVENTION

According to one aspect of the present invention, a system includes a computer having a CPU, a storage medium in communication with the computer and having stored therein information about a first plurality of rooms and a second plurality of rooms in the hotel, the information about the second plurality of rooms including hourly occupancy times for each of the second plurality of rooms and the daily occupancy of the first plurality of rooms at the hotel, wherein the computer is programmed to receive a request for a room at the hotel, the room request including information about arrival and departure at the hotel, compare the information in the room request with the information stored in the database to determine if any rooms in the second plurality of rooms are available between the requested arrival and departure, in response to comparing the information, determining if any rooms are available at the requested arrival and departure times, and if not, analyze the information to determine whether any any pre-existing reservations in the second plurality of rooms can be modified to accommodate the the room request, in response to determining that a pre-existing reservation in the second plurality of rooms can be modified, modify the pre-existing reservation, update the database with changes in the information, send an offer that includes information about available rooms in the second plurality of rooms for the hotel during the requested arrival and departure to be displayed on an electronic device, the information being sent including stays of differing lengths including at least one check-in time and one check-out time, the stays of differing lengths sent based on the hourly occupancy times for rooms during the predetermined time period stored in the database when rooms in the second plurality of rooms are available, and a predetermined price based upon the room request, the predetermined price reflecting the requested length of stay, send an offer that includes information about rooms in the first plurality of rooms when no rooms in the second plurality of rooms are available, receive a room response in response to the information sent regarding available rooms, transmit to the electronic device an assignment of a room at the hotel based upon a positive room response to the offer, and update the information stored in the database based on the positive response, the updated information to be used with the next request for a room, thereby reducing a number of hours that rooms in the second plurality of rooms are empty.

According to another aspect of the present invention, a A method of maximizing room rentals at a hotel, the hotel offering a first plurality of rooms with a standard check-in and check-out times and a second plurality of rooms with variable check-in and check-out times that includes storing in a database information about rooms in the hotel, the database associated with a computer system associated with the hotel, the computer system being accessible via electronic communication from a plurality of locations, the information about the second plurality of rooms including hourly occupancy times for each of the second plurality of rooms and the occupancy of the first plurality of rooms at the hotel receiving a request for a room at the hotel, the room request including information about arrival and departure at the hotel, comparing the information in the room request with the information stored in the database to determine if any rooms in the second plurality of rooms are available between the requested arrival and departure, in response to comparing the information, determining if any rooms are available at the requested arrival and departure times, and if not, analyzing the information to determine whether any any pre-existing reservations in the second plurality of rooms can be modified to accommodate the the room request, in response to determining that a pre-existing reservation in the second plurality of rooms can be modified, modifying the pre-existing reservation, updating the database with changes in the room information, sending an offer that includes information about available rooms in the second plurality of rooms for the hotel during the requested arrival and departure to be displayed on an electronic device, the information being sent including stays of differing lengths, the stays of differing lengths sent based on the hourly occupancy times for rooms during the predetermined time period stored in the database when rooms in the second plurality of rooms are available, and a predetermined price based upon the room request, the predetermined price reflecting the requested length of stay, sending an offer that includes information about rooms in the first plurality of rooms when no rooms in the second plurality of rooms are available, receiving a room response in response to the information sent regarding available rooms, transmitting to the electronic device an assignment of a room at the hotel based upon a positive room response to the offer; and updating the information stored in the database based on the positive response, the updated information to be used with the next request for a room, thereby reducing hours that rooms in the second plurality of rooms are empty.

In some embodiments, the variable check-in times for the second plurality of rooms are between midnight and 3 pm at the hotel location.

In other embodiments, the information stored in the database is used to schedule room cleaning personnel other than from 10 in the morning until 3 in the afternoon at the hotel location.

### BRIEF DESCRIPTION OF THE DRAWINGS

FIG. 1 is a block diagram of a Room Reservation System according to one embodiment of the present invention;

FIG. 2 is flow chart illustrating one embodiment of a method of maximizing times rooms are rented according to the present invention;

FIG. 3 is a screen shot of an industry standard reservation screen;

FIG. 4 is a screen shot composite showing the calendaring for a reservation;

FIG. 5 is a screen shot of a reservation screen according to the present invention showing the ability to select a check-in and a check-out time;

FIG. 6 is a screen shot showing the price of the reservation of FIG. 3 as a total price, without additional fees;

FIG. 7 is a sample of a standard departure report showing information about the guests staying on property;

FIG. 8 is a sample of a stay over report;

FIG. 9 is a sample of an arrival report;

FIG. 10 is a sample of a modified departure report showing the departure times for the guests;

FIG. 11 is a sample of a modified stay over report showing the departure times for the guests; and

FIGS. 12 and 13 show an example of a 250 room resort and the effect of allowing for staggered check-in and check-out times and the revenue generated.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

Today's travelers want to have control over their stay experiences. The ability of guests to customize their stay and the willingness of a hotel to accommodate both arrival and departure times (check-in and check-out) is the surest predictor of customer satisfaction. Consider the example of a tourist who arrives to New York on Friday night at 9 pm and plans to stay until 6 pm Sunday night. This tourist would like to book a room for 45 hours. However, most of the hotels in the city offer the traditional 3 pm check in and 12 pm check out. The timeframes of the periods when this tourist needs a room and when hotels are able to accommodate him do not overlap. The tourist will get a room from 9 pm Friday until 12 pm Sunday. He will pay for 3 pm-9pm time on Friday, even though he doesn't need the room then. Moreover, the tourist would be more than willing to pay for the 12 pm-6 pm time on Sunday, but the hotel will not be able to accommodate it. These times represent a missed opportunity for the hotel to generate revenue. They also represent a negative influence on guest satisfactions scores and return potential.

The proposed system changes the traditional approach to valuation of a room from the current per-day pricing to a per-hour approach. This approach is in alignment with the way guests see the value of their room. A guest who pays $120 per room may perceive their purchase as $5 per hour rate. When the guest arrives in the middle of the traditional room day (3pm-12 pm the next day) and need to rent the room regardless, suddenly the previously affordable price of $120 now seems too expensive. The guest is now paying $10 per hour for the remaining 12 hours they will stay in the room. The proposed system will maximize the per-hour value of a hotel's inventory by introducing the automatic review of the remaining inventory of unoccupied rooms in order to offer more premium check-in and check-out times. This automatic process will continue until all premium arrival and departure times have been exhausted and the system returns to its standard arrival and departure times. Once implemented, this process becomes a permanent part of the reservation system and yield management. This process will also provide hotel management with valuable data on arrivals and departures for various demographic groups and segments of market.

Currently, hotels adjust room rates by how sales are trending depending on times of the year, high and low season, and occupancy. The present system will also allow hotels to utilize the same format. When occupancy is high, the hotel can run the present system at a 20% of their bookings. When their occupancy is low, the hotel can run this program as high as 100% of their bookings. For instance, based on a 100 rooms and 50% occupancy, the hotel can run this program with 20 check-outs at 12 pm, another 20 check-outs at 1 pm, and 10 check-outs at 2 pm. Each time a check-out slot (e.g., 12 pm) has been filled, it will no longer be offered as an option visible to the next customer. These numbers can be adjusted to suit individual hotels to meet the demands on their rooms and check-out times.

In the case of not pre-booking an early arrival or late departure, the system will inform the guests that the standard policies and fees will apply and will be almost double that the guest would pay otherwise. The system will also make suggestion about available times for check-in and check-out to better manage the guest's time and avoid the standard (and increased) fees. In addition to informing guests about their potential losses in case of going with the standard times and fees, this system will sell hourly check-ins and check-outs based on appeals to guests' loss-aversion. The empirical research demonstrates that people typically feel the pain of financial loss much more intensely than the pleasure felt from financial gain of the same size. This pain often results in risk-averse behavior, or risk avoidance that is disproportionate to the expected outcome. This risk aversion drives high insurance rates, airline campaigns of “securing a price”, etc. In this case, it will motivate guests to think and select their times of arrival and departure in order to avoid fees.

When a guest picks and clicks one of the checkout options, the price will automatically be generated and shown to the customer as the overall room charge. The choice of early check-ins or late check-out times will not be shown as special fees or extra charges, rather only a total price for the entire stay will be displayed. This will increase guest's satisfaction with the choice, as the guest will not feel like the guest is being charged an additional fee, plus the system allows the guest to maximize the utility of hours spent in the room. The reservation costs will vary based upon how a hotel implements this program. A flat rate can be implemented that automatically adjusts the reservation by a predetermined number of dollars. The reservation can also be calculated by percentages of room type, size, and cost.

Guests can comparison-shop worldwide with a few computer clicks, so hotels try to post low prices to attract bookings and then load up on fees. Add-on fees may mean the difference between a profit and a loss for many hotels. According to a recent study, hotels collect more than $1 billion in add-on fees each year. All the surveys and studies related to customer satisfaction show their intolerance for hidden fees. The tide of complaints about the fees is rising in online forums, travel blogs, and just about everywhere else that frequent travelers swap stories and post reviews. The ability to move from buried fees to an a la carte fee system that is transparent and easy to understand is a very positive move for the hotel industry.

It is important to understand that guests arrive and leave hotels at various times of the day. Those guests who arrive and leave at off hours (outside of the standard check-in checkout times) will migrate down market to hotels that can accommodate their per-hour room utility. For a resort, that would mean no replacement guests and lost customers. The implementation of this system as a part of hotel's yield management process provides a solution to this issue. Every arriving guest is paired to a room that provides close to the maximum per-hour utility. Similarly, guests departing late can maximize their room per-hour utility by checking out at convenient times for them. A guest arriving at 5 pm can be placed in a dedicated 5 pm check-in room with a later checkout if needed and the 12 pm arriving guest can be placed in a dedicated 12 pm room. In both cases, hourly utility is maximized and more profit is made than if both guest were placed into a single universal check-in/checkout room.

The present system will become part of the ongoing strategic planning process of the yield management department at the hotel. The hotel will need to better identify and track early departures, those that leave a day or two early, typically associated with convention attendees, as well as those who leave their room early on the day of departure, as well as requests for early check-ins and late check-outs. This can only be accomplished with the system because the data, particularly for a large hotel would be too extensive to do without such a system. For example, a history of requests, denied and granted will become valuable to forecast future requests and adjust the number of rooms available. This will vary by guest profile. Forecasting the early departures and requests for early check-ins and check-outs will become routine. This knowledge will also allow for a better utilization of the system. Yield management will be able to use prior years' occupancies to accurately forecast for the coming year and properly project the number of early check-in/late check-out time slots that can be available at any given time.

The system allows for an easy and inexpensive way for companies, e.g., hotels, websites, travel agents, etc., to make use of the proposed system. The system will also play an important role in time management of housekeeping and the related labor costs. It will make it possible to predict the daily number of early arrivals or late checkouts and the needed number of housekeeping team members to accommodate these arrivals and departures. The system will provide the management team with the monthly, weekly, and daily occupancy reporting. This report will include the arrival and departure times of all guests allowing the team to not only pre-schedule the needed team members to handle the work, but also to organize the daily cleans in order of arrivals and departures by time.

A J.D. Power and Associates Study has found that the hotel check-in/check-out experience ranks only behind guest room quality as the top driver of overall guest satisfaction. The study of guest complaints reports that the most frequent source of guest dissatisfaction is their arrival experience (after guest room and facility related sources). Guests can sometimes arrive hours before the hotel check-in time. Often without any notice to the hotel. They may also require a late departure due to scheduled events or an airplane flight later in the day. Currently, a front desk clerk handles early check-ins and late check-outs as they are asked (by phone or on arrival) by the guest if the guest may have a check-in earlier in the day or checkout later than the standard time. When a guest asks the reservationist if they can check-in early or check-out late, the answer is “we can't guarantee it, but I will note your request.” Often the guest interprets this as encouraging them that they should try. However, it requires more work by all staff involved (the front office, reservations and housekeeping), so it is not always in the staffs best interest to accommodate these requests. Therefore, when the decision is left up to and made at the staff level, these requests are denied and guests leave frustrated. Guest loyalty is one of the main strategic priorities for any hotel. A frustrated guest will not stay again at the same hotel. Guests are more likely to return to a place where they can manage their vacation better and more efficiently. The present system allows guests to take more control over their travel experience and to create the optimal package including times of arrival and departure. Furthermore, when guests need to leave later than planned, they are faced with an exorbitant fees. The guests may contest it and will fixate on anything that went wrong during their stay in order to get out of the fees associated with late departure. These aggravating experiences (both for the guest and the hotel staff attending to the disgruntled guest) will be avoided when a hotel will operate the the system.

On the operational level, this system will create a way to maximize the actual hours in which a guest can utilize a room. This will result in a better inventory control and will increase occupancy at the next level of unsold/unused hours. The hotel yield management has its roots in airline yield management. Both industries deal with a perishable product—an unsold hotel night or an airline seat are lost forever. The only difference between the two industries is the value over time of the product. A guest can arrive at midnight and purchase what he think would be just a half of a room night. An airline traveler cannot book just a half of a trip. The hotel industry has long neglected the issue of unused hours. The ability of a hotel to allocate a number of rooms for various check-in and check-out times, depending on occupancy, will generate an additional revenue stream, will streamline the turnover of rooms, and will allow for more accurate forecasting by tracking early arrivals and late departures. For instance, there can be major differences in the profile of guests visiting a certain property (convention, weekday vs weekend, seasonal, etc.). Optimal check-in/check-out times and rate can be found for these segments of market at a particular property.

In addition, the single check-in/check-out time put a strain on the housekeeping team. They are expected to clean and turn over all vacated rooms in a short time. For instance, if a hotel has a team of 10 housekeeping staff and 100 rooms are vacated in a single day, the staff has 3 hours to turn over 100 rooms. If one person can clean a room in 20 minutes, this will mean 90 cleaned rooms in a 3 hour period of time. However, 10 rooms will remain uncleaned/unturned. The pick your check-in/check-out time system will create a work climate in which this team will better plan their work hours by essentially making the cleaning time longer. This in turn will maximize their perceived efficiency and work-related satisfaction. While hotel administration makes guests satisfaction a priority, team member satisfaction is no less important. The satisfaction of front desk personnel will increase as well as they will not have to deal with a high number of guests all checking-in/checking-out at the same time. Additionally, they will not have to handle the late check-out or early check-in requests. They are not well positioned to handle these requests and the potential revenue increase that these requests can bring is left untapped.

There is also another type of traveler, and that is one that needs an “unconventional stay.” An unconventional stay is a reservation that does not match the industry standards for check-in and check-out times. These guests typically arrive after the industry check-in and leave earlier than the industry check-out times. For instance, a business traveler will arrive at his hotel at 11 pm and have to be out of his room for his meeting by 7 am. The hotel industry does not accommodate this guest. This guest needs to make a reservation between the industry standard arrival and departure times. This not only inconvenient to the guest, but also is a poor use of inventory that will now go un-utilized. This block of hours (in which the guest is not utilizing the room) could be used to increase revenue and additional occupancy. Unconventional stay is an underutilized market with the potential to create significant increase in revenue and a better usage of unused inventory. As a part of the “pick your check-in/check-out” program, the system will be better able to track this market by making changes to the length-of-stay reports.

The industry uses length-of-stay reports to help increase their occupancy. These reports allow the yield management team to measure the actual usage of rooms in the inventory. In conjunction with these reports, the system moves each reservation to a different room until it utilizes the maximum amount of days. The fact that system operates on a monthly/weekly/daily basis leaves large gaps of unused hours that are not accounted for, not utilized, and generates no revenue. The system will calculate the exact usage of each hotel room by the hour. This will create blocks of times which can be now used for the unconventional stay visitors. Some of the examples of unconventional stays that now can be accommodated within these hours of unused inventory include:

Layovers—when a flight has been canceled or delayed. This gives a place for the passenger to spend their time in comfort and relaxation.

Mini-stays—a mini can be anything from a day at the beach to a day at the ski resorts. This allows the guest a place to relax, clean up, and spend some down time before they travel home.

Nap rooms—a nap room is set up for a traveler that is commuting long distances by car and does not have the luxury of staying an entire night in a hotel room.

Conference—these rooms are set up for one-on-one conferences or business meetings for less than 6 participants.

Study rooms—need a quiet place to study? These rooms are set up for people that are out of town and need a place to work in private secure environment that also offers wife, food and beverage, and a place to shower and change.

These hours can be marketed in numerous ways that will match any type of hospitality company. While the ability to use hours for an unconventional stay creates an illusion of control on the part of the guest, in fact it gives the hospitality industry a tighter control over their rooms, inventory, and overall marketing. The guests may feel that they have one hundred percent control over their booking arrangements right down to their check-in/check out times, but in actuality the guests are receiving only the additional hours that suit the company's inventory needs/availability.

It would be impossible for this program to be managed over the phone or at the front desk by a clerk. This system must become a part of the reservation system for it to reach its full potential and maximize the overall usage of the inventory. In turn it will allow hospitality companies to reach their full market potential. When this system becomes a part of the reservation system, it will maximize efficiency for housekeeping department. When the system moves around the inventory, it will also keep a set amount of time in which a room needs to be cleaned. These times can be moved around to make sure that the maximum efficiency for departure cleans is met. Now specific reports can be generated for the housekeeping department indicating projected efficiency by length of clean, type of check-out, and man-hours per room. These reports will be used to better manage the housekeeping department and control hourly waste. Moreover, the system allows for reservations to be changed to accommodate other reservations. For example, if one reservation is assigned to a particular room, and a second reservation comes in that would be better in the room assigned to the first reservation, the system can move the first reservation to another room (and perhaps an even better room for the guest) if the system finds that more hours can be used by moving the first reservation to another room.

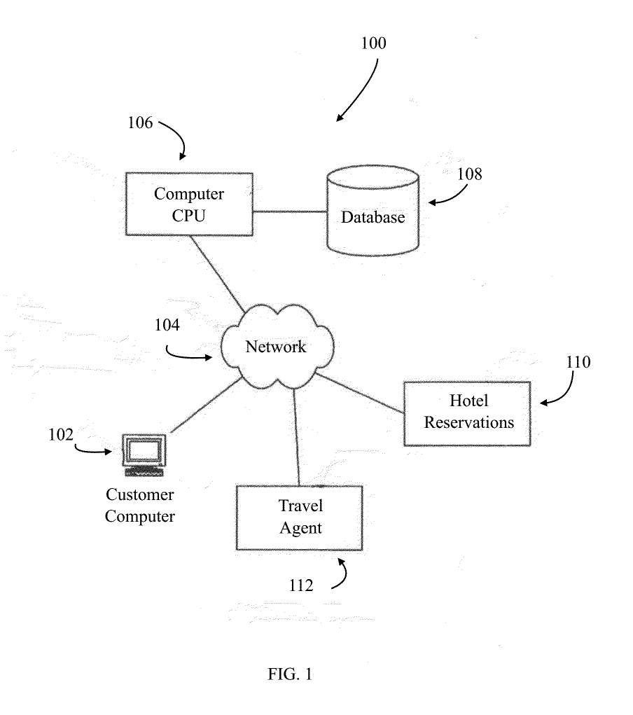

Turning now to the figures and specifics of the system, FIG. 1 illustrates system 100 according to one embodiment of the invention. As may be understood from this figure, in this embodiment, the system 100 includes at least one guest computer 102 that is connected (e.g., via a network 104 such as a LAN or a global communications network, such as the Internet) to communicate with a computer/CPU 106. In one embodiment of the invention, the computer/CPU 106 is configured for retrieving data from, and for saving data to, a database 108 that may be stored on (or, alternatively, stored remotely from) the computer/CPU 106. In the embodiment shown in FIG. 1, the database 108 is maintained on a computer that is remote from the computer/CPU 106, although they may within the same building, room, or housing. Also able connect to the computer/CPU 106 is a hotel reservations computer 110. This hotel reservation computer is also in communication with the computer/CPU 106 so that a hotel guest may call the hotel directly rather than accessing the computer/CPU 106 through the guest computer 102. Similarly, reservations may also be made through other computers, such as a travel agent's computer 112.

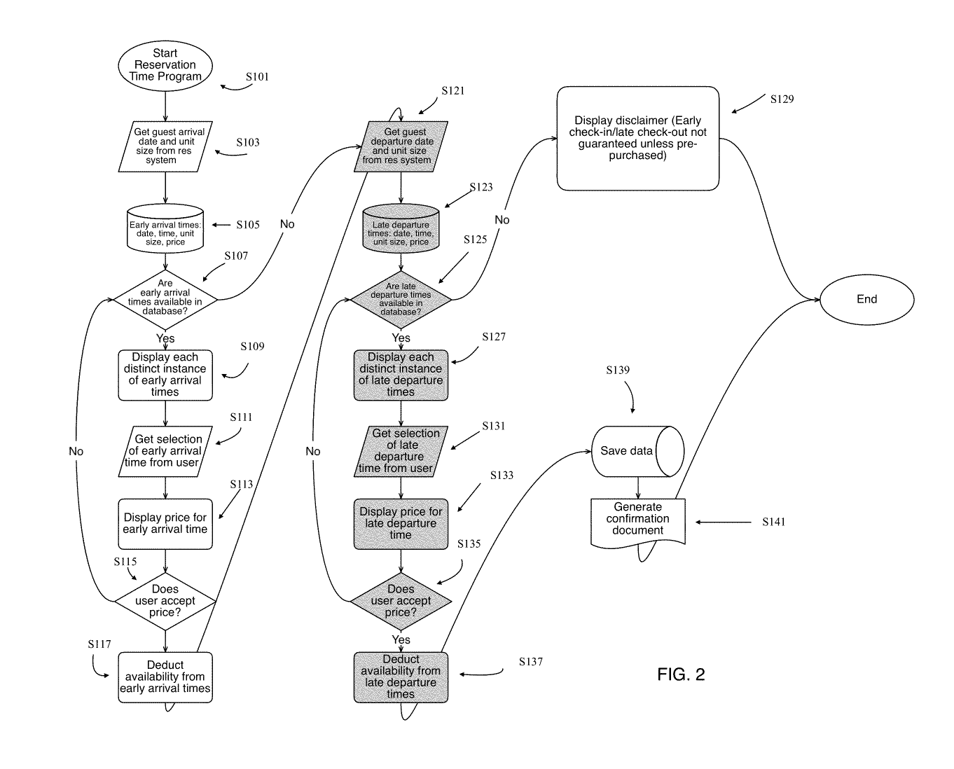

In FIG. 2, one embodiment of a guest's interaction with the system is illustrated. At step S101, the guest begins communication with the computer/CPU 106 through the network 104, which may include a reservation program stored on the computer/CPU 106. The guest-to-be then enters the date of arrival, length of stay, and number of persons in the party, which is then transmitted to the computer/CPU 106 at step S103.

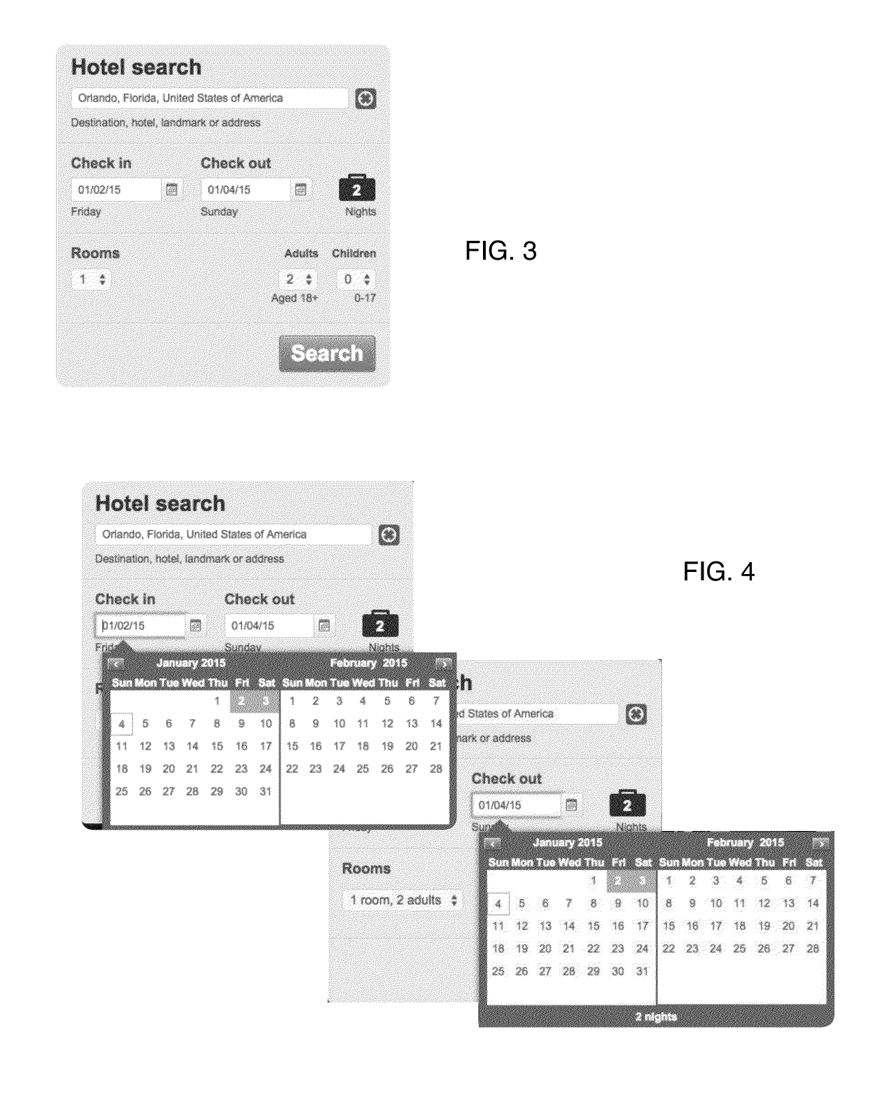

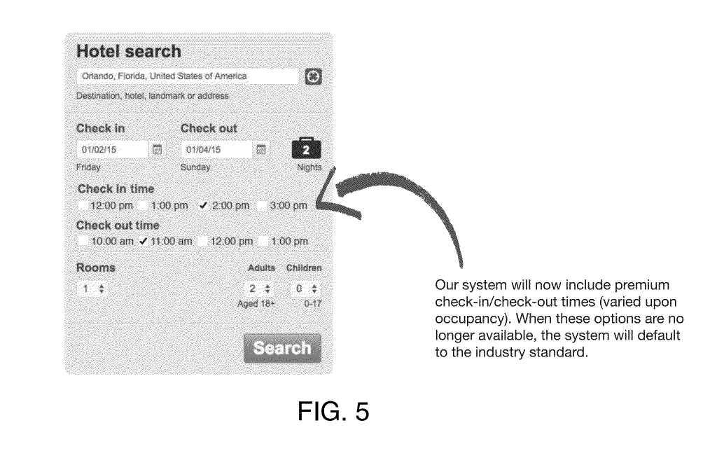

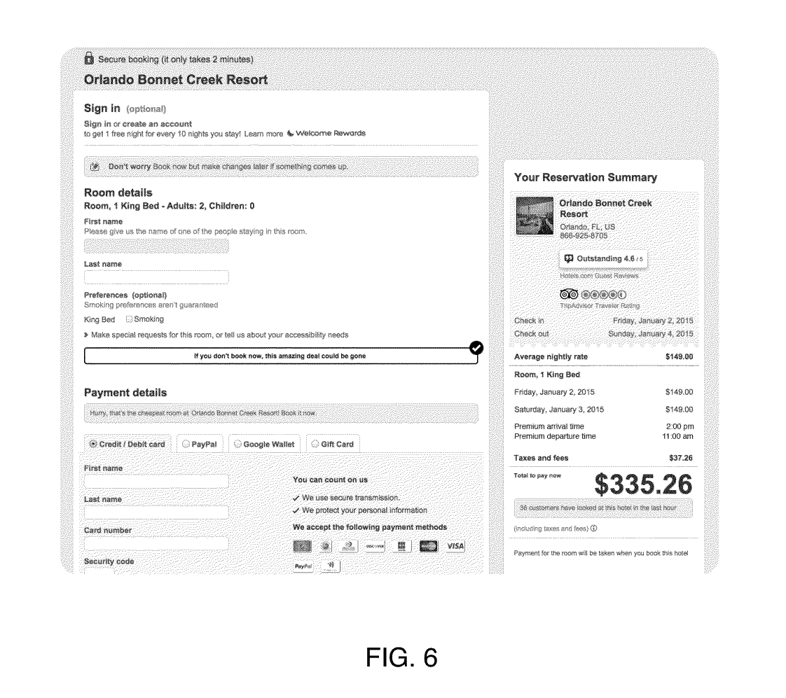

The computer/CPU 106 then checks the information provided by the guest against the data in the database 108 (Step S105) and determines if there are early arrival times available (Step S107). If there are available early check-in times, these are transmitted to the guest-to-be at the computer 102. Step S109. The typical industry-standard reservation screen is illustrated in FIG. 3 with the calendars illustrated in FIG. 4 to assist the customer in making the reservations. However, instead of the standard reservation screen (FIG. 3), the computer/CPU 106 provides, if available, a number of times for early check-in. See FIG. 5.

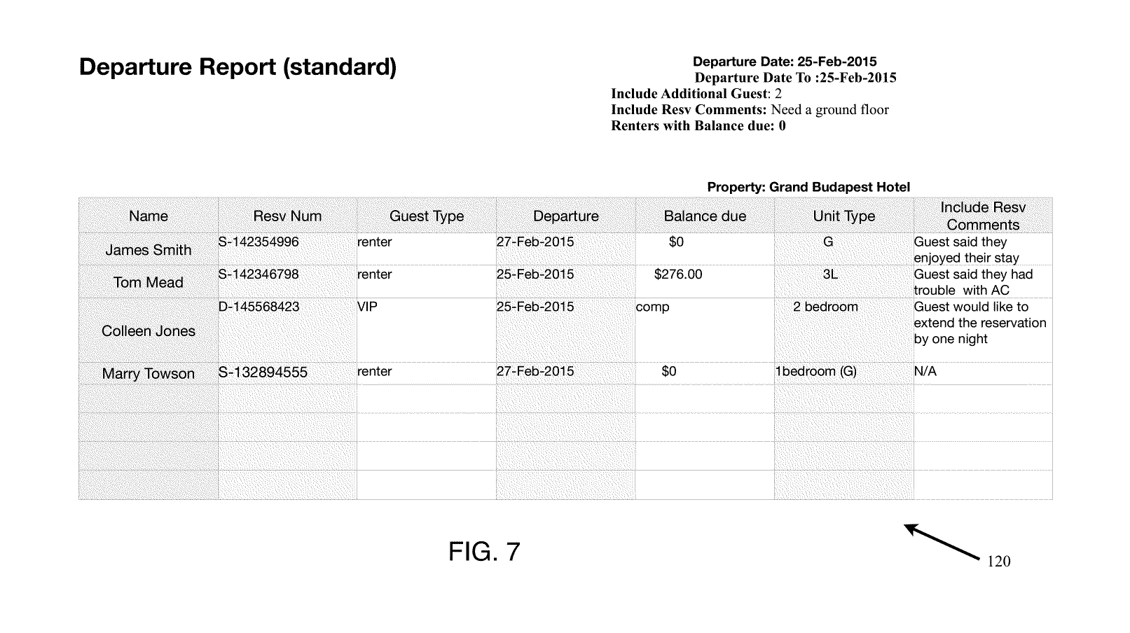

It should be noted that as illustrated on the screen in FIG. 5, the computer/CPU 106 can check for both check-in and check-out times simultaneously at step S107, rather than just for early or later check-in times. The reservation screen may then appear as illustrated in FIG. 5 with both the check-in and check-out times. As noted above, there may be a plurality of check-in/check-out times that are provided to the guest, based on the availability of rooms at the property, from no early check-in and check-out times to three or more options. Additionally, there may be either check-in or check-out times, but not both. FIG. 5 shows as an example that the guest wants to reserve one room for two nights and with two people (number of adults and/or children to determine the size/type of room necessary for the reservation for better accuracy of the system) and that the system has determined that there are four different check-in and four different check-out times. FIG. 5 shows that the guest selected the 2:00 pm check-in (1-2 hours earlier than normal hotel check-in times) and the 11:00 am checkout. See Step S111, where the guest responds to the information provided by the system 100. FIG. 6 illustrates that the system 100 provides a price for the entire stay, along with the premium arrival and departure times that have been arranged. See Step S113, where just the price for the arrival times are provided. At step S115, the guest can then accept the price for the premium arrival time, which causes the system 100 at step S117 to update the database with regard to the room being chosen. If the guest does not accept the price for the arrival time, then system 100 goes back to determine if there are other arrival times at different prices at S107.

If there are no early arrival times available at step S107 or the guest accepts the price for the stay, including the premium arrival time, then the system proceeds to step S121. The system 100 or computer/CPU 106 then checks the information provided by the guest against the data in the database 108 (Step S123) and determines if there are late departure times available (Step S125). If there are available late check-out times, these are transmitted to the guest-to-be at the computer 102. Step S127. If there are not any late departure times available, then the guest is provided a standard check-out with a reminder of the property's early check-in/late check-out procedure at step S129.

When there are late check-out options available, then the guest can select the check-out time desired at step S131. The system 100 then provides the price for the stay with the selected check-out at step S133. If the price and times are acceptable and the guest accepts the reservation at step S135, the system 100 updates the data at step S137. The reservation data is then saved at step S139 and a confirmation is sent to the guest at step S141.

As noted briefly above, the system 100 can also provide the optional check-in/check-out times at the same time, thereby eliminating the second querying of the system 100, as in steps S121-S137. Returning to the figures, FIG. 5 shows the available check-in and check-out times. FIG. 6 shows the selected check-in and check-out times along with the price. The system 100 is then updated if the guest reserves the room. If not, then the system 100 can check for other possible options based on the information provided by the guest.

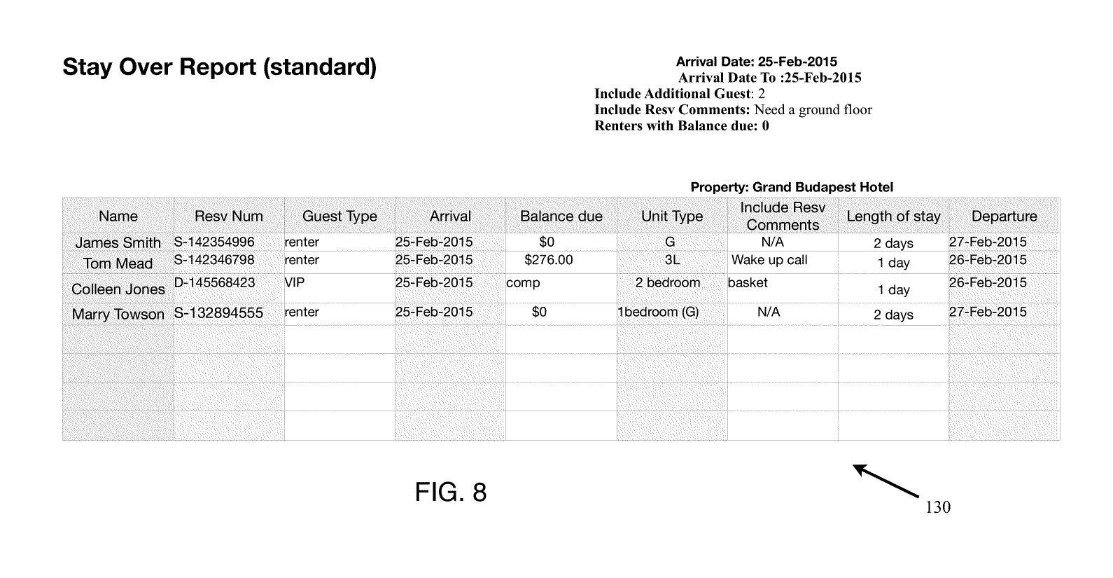

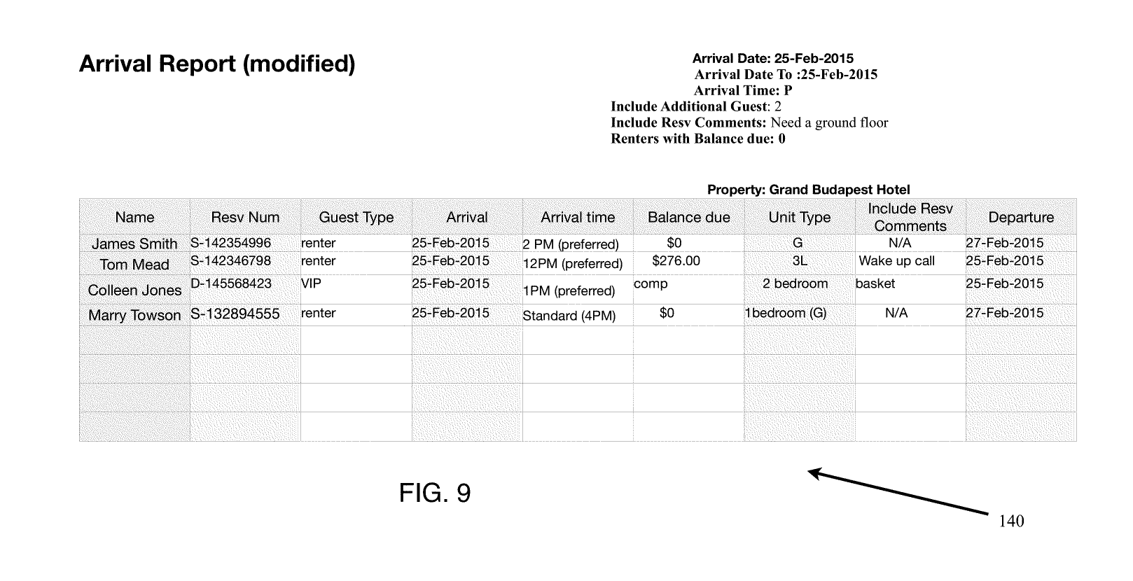

As noted above, the system 100 can provide reports to the property's management to better plan the maintenance staff along with other personnel. One of the reports that is provided at each property on a daily basis is the departure report 120, one example of which is illustrated in FIG. 7. This report includes, among other information, the departures and room types-both important in planning for turning or cleaning the rooms. FIG. 8 has another important report, a stay-over report 130, which identifies which guests are going to be staying in their rooms. As one of skill in the art knows, it does not take as long to turn a room where the guests are staying as a room where the guests are leaving and new guests are coming in. Also, there would be some flexibility for cleaning the rooms of those guests staying another night, while the rooms with the new guests must be cleaned by the check-in time.

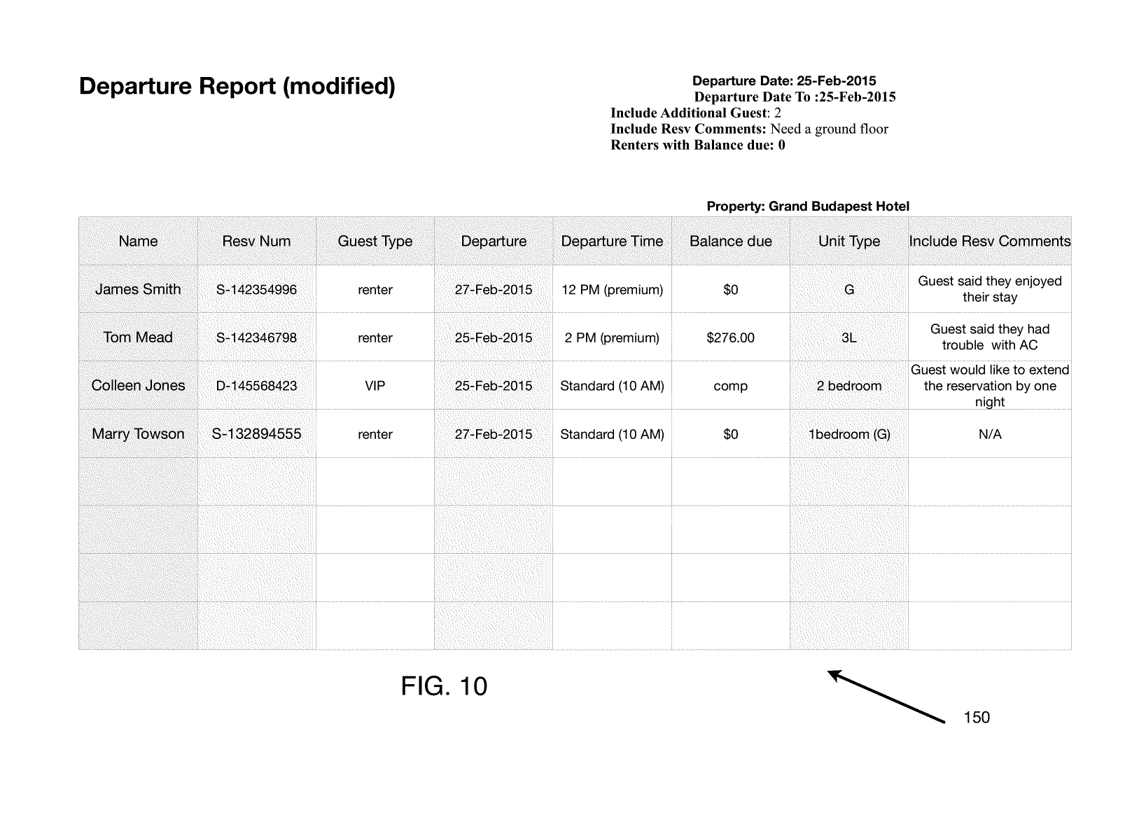

Another report that can be provided by a standard reservation system is an arrival report. The arrival report provides information on the guests arriving and in which rooms they will be staying. The staff can then be certain that these rooms are ready by check-in time. With the present system 100, a modified arrival report 140 is provided as illustrated in FIG. 9. The modified arrival report 140 has the arrival times of the guests and the rooms. This allows the staff to know which rooms to clean first and which ones can wait.

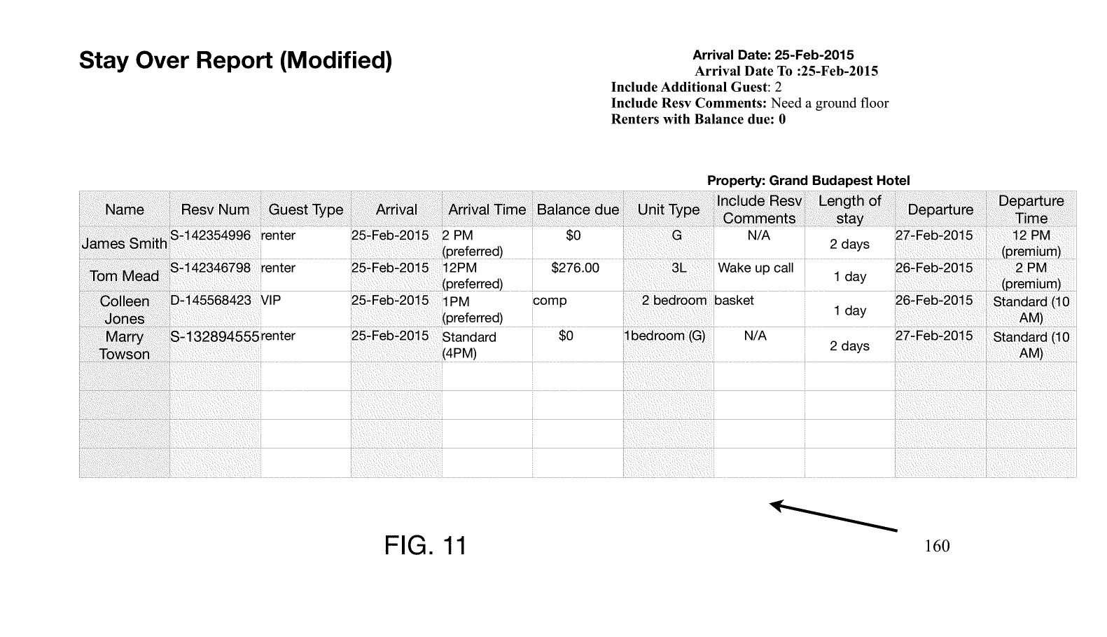

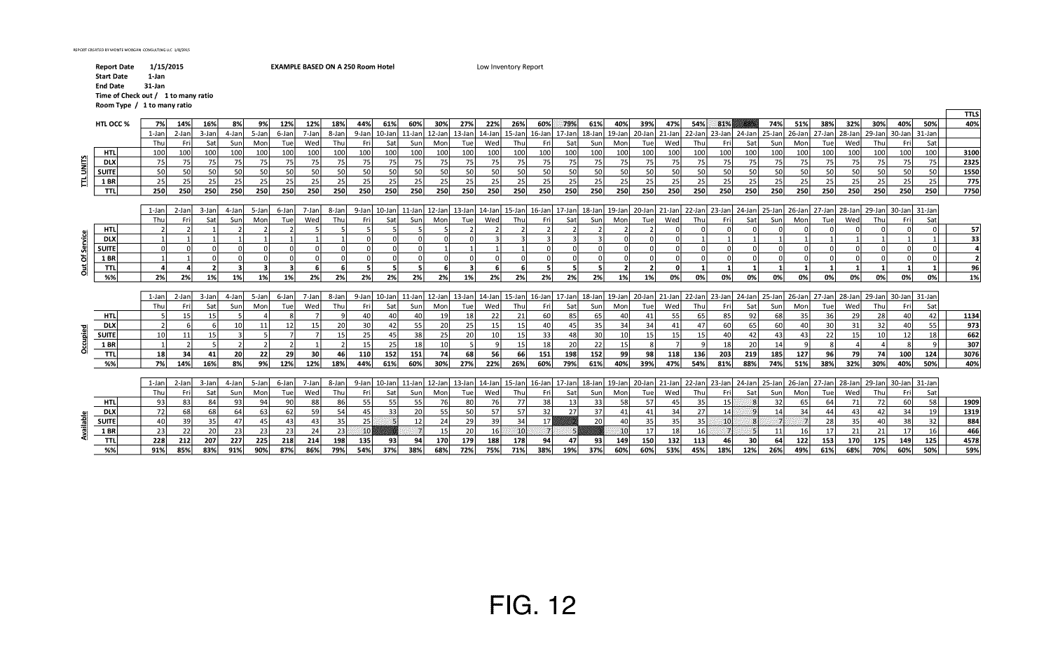

Similarly, a modified departure report 150 is illustrated in FIG. 10. Again, the departure times for the guests are provided, again allowing for the modification of a cleaning schedule and possibly the staging of the cleaning staff. A modified stay-over report 160 is illustrated in FIG. 11.

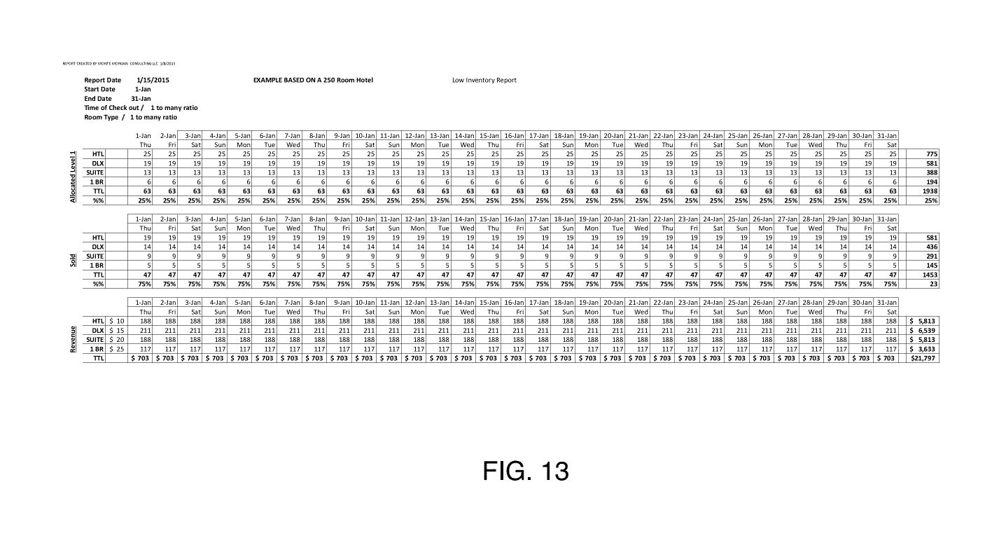

As an example, FIGS. 12 and 13 illustrate what happens to the revenue generated by a 250 room hotel. In this example, the hotel has 4 Unit Types: 100 Hotel Rooms; 75 Deluxe Rooms; 50 Suites; and 25 1-Bedroom Rooms. The report 170 in FIG. 12 is divided into four sections 172-178. The first section 172 shows total units by unit type for each day of the month, and the data for the occupancy across the top—see next section. This allows the management to see at a glance those dates that the allocation of the rooms for the program be monitored more closely as explained in more detail below. The second section 174 shows the number of units that are expected or are historically unavailable. The third section 176 shows the number of rooms that are occupied by date and hotel room type. The fourth section 178 are then those units are available for each day of the month by room type. Of note are the following rooms: very low availability of 1 bedroom on January 9-11 and January 17-19; suites on January 16-17; and a number of types around January 22-26. Again, these numbers can allow management to change the availability of premium check-ins/check-outs. Turning to FIG. 13, there are three sections 180-184. Section 180 illustrates one level of allocation for the program of premium check-ins/check-outs. As illustrated, of the total number of units (250), 25% of the units will be set aside for the premium check-ins/check-outs. The number of rooms allocated can be programmed to be a certain percentage across the board, or manually entered by room type and dates available. The system allows for flexibility in the manner of setting the rooms up. For example, the property manager may allow 5 rooms for a 9:00 am check in a price of $25.00, but allow 15 rooms for a 1:00 pm check for only a $10.00 charge. The charges may be different based on time of day and demand, and also depending on staffing levels for guest service. This allows, as shown below, to make higher revenues for those guest that need an early check in. This would benefit the Resort because during slow times, there is a charge for $10.00 for an early check in, but during Peak Times, have fee that is higher.

Section 182 shows that the number of rooms that are set aside for the premium check-ins/check-outs. Of the 25% that were set aside in section 180, section 182 assumes that 75% of those were rented. So of the 1938 room-nights for the premium check-ins/check-outs, 1438 were rented. Assuming that the extra fees collected for the premium check-ins/check-outs ($10 for hotel rooms; $15 deluxe rooms; $20 for suites; and $25 for 1 bedroom rooms), the total extra income for the month of January is almost $22,000.00—and annually that would be more than a quarter of a million dollars!

The system would keep the data for each of the days, room types, and charges that are acceptable to the guests. The system could be programmed to automatically recognize the trends for the room types, time of year, etc. to automatically set the prices and the number of rooms. Also knowing when the guests are checking out, allows for the appropriate staffing of the housekeeping functions. If for example, people are checking out later in the summer at a beach resort to take advantage of the beach, then the staff could dispersed throughout the day and even shifted to later in the day than normal.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A room reservation system for maximizing the time that at least some rooms in a hotel room are used comprising:
a computer having a CPU;
a storage medium in communication with the computer and having stored therein information about a first plurality of rooms and a second plurality of rooms in the hotel, the information about the second plurality of rooms including hourly occupancy times for each of the second plurality of rooms and the daily occupancy of the first plurality of rooms at the hotel; wherein the computer is programmed to:
receive a request for a room at the hotel, the room request including information about arrival and departure at the hotel;
compare the information in the room request with the information stored in the database to determine if any rooms in the second plurality of rooms are available between the requested arrival and departure;
in response to comparing the information, determining if any rooms are available at the requested arrival and departure times, and if not, analyze the information to determine whether any any pre-existing reservations in the second plurality of rooms can be modified to accommodate the the room request;
in response to determining that a pre-existing reservation in the second plurality of rooms can be modified, modify the pre-existing reservation;
update the database with changes in the information;
send an offer that includes information about available rooms in the second plurality of rooms for the hotel during the requested arrival and departure to be displayed on an electronic device, the information being sent including stays of differing lengths including at least one check-in time and one check-out time, the stays of differing lengths sent based on the hourly occupancy times for rooms during the predetermined time period stored in the database when rooms in the second plurality of rooms are available, and a predetermined price based upon the room request, the predetermined price reflecting the requested length of stay;
send an offer that includes information about rooms in the first plurality of rooms when no rooms in the second plurality of rooms are available;
receive a room response in response to the information sent regarding available rooms;
transmit to the electronic device an assignment of a room at the hotel based upon a positive room response to the offer; and
update the information stored in the database based on the positive response, the updated information to be used with the next request for a room,
thereby reducing a number of hours that rooms in the second plurality of rooms are empty.

2. The system according to claim 1, wherein the time between the check-in time and check-out time is less than 12 hours.

3. The system according to claim 1, wherein the time between the check-in time and check-out time is less than 6 hours.

4. The system according to claim 1, wherein the information stored in the database includes room numbers, occupancy of the room by hour for a predetermined time period, room type, guest name, and reservation number.

5. The system according to claim 1, wherein the information stored in the database is used to schedule room cleaning personnel other than from 10 AM until 3 PM at the hotel location.

6. The system according to claim 1, wherein the room response is either positive or negative.

7. The system according to claim 1, wherein the stays of differing lengths are shorter than 12 hours.

8. The system according to claim 1, wherein the stays of differing lengths are shorter than 6 hours.

9. The system according to claim 1, wherein the room response is either positive or negative.

10. A method of maximizing room rentals at a hotel, the hotel offering a first plurality of rooms with a standard check-in and check-out times and a second plurality of rooms with variable check-in and check-out times, comprising:
storing in a database information about rooms in the hotel, the database associated with a computer system associated with the hotel, the computer system being accessible via electronic communication from a plurality of locations, the information about the second plurality of rooms including hourly occupancy times for each of the second plurality of rooms and the occupancy of the first plurality of rooms at the hotel;
receiving a request for a room at the hotel, the room request including information about arrival and departure at the hotel;
comparing the information in the room request with the information stored in the database to determine if any rooms in the second plurality of rooms are available between the requested arrival and departure;
in response to comparing the information, determining if any rooms are available at the requested arrival and departure times, and if not, analyzing the information to determine whether any any pre-existing reservations in the second plurality of rooms can be modified to accommodate the the room request;
in response to determining that a pre-existing reservation in the second plurality of rooms can be modified, modifying the pre-existing reservation;
updating the database with changes in the room information;
sending an offer that includes information about available rooms in the second plurality of rooms for the hotel during the requested arrival and departure to be displayed on an electronic device, the information being sent including stays of differing lengths, the stays of differing lengths sent based on the hourly occupancy times for rooms during the predetermined time period stored in the database when rooms in the second plurality of rooms are available, and a predetermined price based upon the room request, the predetermined price reflecting the requested length of stay;
sending an offer that includes information about rooms in the first plurality of rooms when no rooms in the second plurality of rooms are available;
receiving a room response in response to the information sent regarding available rooms;
transmitting to the electronic device an assignment of a room at the hotel based upon a positive room response to the offer; and
updating the information stored in the database based on the positive response, the updated information to be used with the next request for a room,
thereby reducing hours that rooms in the second plurality of rooms are empty.

11. The method according to claim 10, wherein the variable check-in times for the second plurality of rooms are between midnight and 3 pm at the hotel location.

12. The method according to claim 10, wherein the variable check-out times for the second plurality of rooms are after noon at the hotel location.

13. The method according to claim 10, wherein the time between the check-in time and check-out time is less than 12 hours.

14. The method according to claim 10, wherein the time between the check-in time and check-out time is less than 6 hours.

15. The method according to claim 10, wherein the information stored in the database includes room numbers, occupancy of the room by hour for a predetermined time period, room type, guest name, and reservation number.

16. The method according to claim 10, wherein the information stored in the database is used to schedule room cleaning personnel other than from 10 in the morning until 3 in the afternoon at the hotel location.

17. The method according to claim 10, wherein the room response is either positive or negative.

18. The method according to claim 10, wherein the stays of differing lengths are shorter than 12 hours.

19. The method according to claim 10, wherein the stays of differing lengths are shorter than 6 hours.
